(19) United States
(12) Patent Application Publication
(10) Pub. No.: US 2010/0196761 A1
(43) Pub. Date: Aug. 5, 2010

(54) GRANULAR POWDER OF TRANSITION METAL COMPOUND AS RAW MATERIAL FOR CATHODE ACTIVE MATERIAL FOR LITHIUM SECONDARY BATTERY, AND METHOD FOR ITS PRODUCTION

(75) Inventors: Koji Tatsumi, Chigasaki-shi (JP); Yuki Nagura, Chigasaki-shi (JP); Kazuya Hiratsuka, Chigasaki-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: AGC Seimi Chemical Co., Ltd., Chigasaki-shi (JP)

(21) Appl. No.: 12/750,745

(22) Filed: Mar. 31, 2010

Related U.S. Application Data
(63) Continuation of application No. PCT/JP08/69948, filed on Oct. 31, 2008.

(30) Foreign Application Priority Data
Nov. 1, 2007 (JP) 2007-285509
Nov. 1, 2007 (JP) 2007-285513

(51) Int. Cl. H01M 4/131; H01M 4/58; C01D 15/02

(52) U.S. Cl. 429/223; 429/231.95; 423/594.6; 423/594.4; 252/182.1

(57) ABSTRACT

To provide a transition metal compound granule serving as a raw material for a cathode active material for a lithium secondary battery, which has high packing density, large volume capacity density and high safety and which is excellent in durability for charge and discharge cycles.

A transition metal compound granule serving as a raw material for a positive electrode material for a lithium ion secondary battery, which comprises particles containing at least one element selected from the group consisting of nickel, cobalt and manganese and having an average particle size of the primary particles being at most 1 μm and which is substantially spherical and has an average particle size D50 of from 10 to 40 μm and an average pore size of at most 1 μm.

### TECHNICAL FIELD

The present invention relates to a transition metal compound granule serving as a raw material for a lithium-containing composite oxide for a positive electrode for a lithium secondary battery, which has high packing density, large volume capacity density and high safety and which is excellent in durability for charge and discharge cycles, a method for producing such a transition metal compound granule, a lithium-containing composite oxide for a positive electrode for a lithium secondary battery, prepared by using such a transition metal compound granule, a positive electrode for a lithium secondary battery, containing such a lithium-containing composite oxide, and a lithium secondary battery.

### BACKGROUND ART

In recent years, along with rapid progress in the field of information-related devices or communication devices, such as personal computers or mobile phones, there has been an increasing demand for a non-aqueous electrolyte secondary battery such as a lithium secondary battery which is small in size and light in weight and has a high energy density. As a cathode active material for such a non-aqueous electrolyte secondary battery, a composite oxide of lithium and a transition metal (which may be referred to also as a lithium-containing composite oxide in the present invention) such as LiCoO₂, LiNiO₂, LiNi_{0.8}Co_{0.2}O₂ or LiMn₂O₄, has been known.

Particularly, a lithium secondary battery using a lithium cobalt composite oxide (LiCoO₂) as a cathode active material and using a lithium alloy and carbon such as graphite or carbon fiber as a negative electrode, is widely used as a battery having a high energy density, since it is thereby possible to obtain a high voltage at a level of 4 V.

Such a lithium-containing composite oxide is usually produced by preliminarily preparing particles of a transition metal compound having a prescribed average particle size, and mixing the particles with a lithium compound, followed by firing. That is, when particles of a transition metal compound having a prescribed average particle size are used, it is possible to prepare a lithium-containing composite oxide having a particle size suitable as a cathode active material, and further, when such particles are mixed with a lithium compound, the process can be simplified.

On the other hand, as a method for producing such particles of a transition metal compound, a method has, for example, been proposed wherein an alkaline aqueous solution such as a sodium hydroxide aqueous solution is dropwise added to a solution having a transition metal compound such as nickel sulfate, cobalt sulfate or manganese sulfate dissolved, so that crystal particles are precipitated over a long time until the particles will grow to a sufficiently large size, and then, such crystal particles are subjected to filtration, washing and drying (Patent Document 1).

Further, as another method for producing such particles of a transition metal compound, a method has been proposed wherein a transition metal compound such as a nickel compound, a cobalt compound or a manganese compound is pulverized and dispersed to obtain a slurry, which is spray-dried under prescribed conditions by using e.g. a spray drier, to form a granular product (Patent Documents 2 to 8).

Patent Document 1: JP-A-2007-070205

Patent Document 2: JP-A-2002-060225

Patent Document 3: JP-A-2005-123180

Patent Document 4: JP-A-2005-251717

Patent Document 5: JP-A-2003-034536

Patent Document 6: JP-A-2003-034538

Patent Document 7: JP-A-2003-051308

Patent Document 8: JP-A-2005-141983

### DISCLOSURE OF THE INVENTION

### Object to be Accomplished by the Invention

However, a positive electrode for a lithium secondary battery containing a lithium-containing composite oxide produced by using, as a raw material, the above-described particles of a transition metal compound obtained by such a conventional method, is not one which fully satisfies various properties such as the packing density, the volume capacity density, the stability against heat when heated (which may sometimes be referred to as safety in the present invention), the durability for charge and discharge cycles, etc.

For example, by the method disclosed in Patent Document 1, it is difficult to make the crystal particles to be round and large-sized, and a very long time is required to make the crystal particles large-sized, and the particle shape tends to be deformed in the process for large sizing, whereby it tends to be difficult to obtain spherical crystal particles. Further, such crystal particles have a large average pore size in the particles and the porosity of the crystal particles tends to be low at a level of 55%, whereby in the firing step after mixing them with a lithium compound, the mixture cannot uniformly and densely be sintered. As a result, the packing density and the volume capacity density of the resulting lithium-containing composite oxide were not sufficient.

Further, Patent Document 2 discloses a lithium cobalt composite oxide which is produced by spray-drying a slurry having a cobalt compound dispersed by a disk-rotating spray dryer. In this case, the concentration of the slurry to be sprayed is 100 g/l i.e. about 10 wt %, and thus, granular particles are produced by spraying a slurry having an extremely low solid content concentration. The produced granular particles have large voids on the surface and interior of the particles, and the lithium composite oxide will also have similar voids. The average pore size in the particles is as large as 1.5 μm, and the packing density and the volume capacity density of the lithium cobalt composite oxide obtainable by using such granular particles will also be low, and such a composite oxide was not practically useful as a raw material for a cathode active material.

Further, Patent Documents 3 and 4 disclose granular particles produced by subjecting a slurry having a nickel compound, a cobalt compound and a manganese compound dispersed to pulverization treatment by e.g. a beads mill, followed by spray-drying by a spray drier. In this case, the method includes a step of pulverizing a slurry having various materials dispersed, by e.g. beads mill, whereby impurities derived from the dispersing media are likely to be included, and the slurry viscosity tends to be high. Further, the slurry is sprayed in such a state that the impurities are contained, the solid content concentration is low, and the viscosity is high, and as a result, the obtainable granular particles will contain impurities, particles being hollow inside will be formed, dense portions and roughened portions will be randomly present, the pore size of granular particles tends to be large, and the porosity tends to be low. Therefore, such is not practically useful as a raw material for a cathode active material.

Further, in Patent Document 3, a slurry having a solid content concentration of 42 wt % and a high viscosity of 2,830 mPa·s, or a slurry having a solid content concentration of 42 wt % and a high viscosity of 6,625 mPa·s, is used. Further, in Patent Document 4, a slurry having a concentration of from 12 to 17 wt % and a viscosity of from 250 to 1,120 mPa·s is used. Further, a lithium cobalt composite oxide obtained by using such granular particles, is not dense as many voids are present among primary particles, whereby the packing density and volume capacity density were low, and it had no adequate performance.

Patent Documents 5 to 8 disclose that a slurry having a lithium compound, a nickel compound, a cobalt compound and a manganese compound dispersed, is subjected to pulverization treatment by e.g. a beads mill, and then, the obtained slurry is sprayed to prepare a granular product containing a lithium compound and a transition metal compound, and the granular product is fired to produce a lithium-containing composite oxide. However, also the methods disclosed in these documents include a step of pulverizing a slurry having various materials dispersed, whereby impurities derived from the dispersing media will be contained. Further, when the lithium-containing composite oxide is prepared from the granular product containing the lithium compound, lithium atoms tend to react with the transition metal compound and enter into crystals of the transition metal compound in the firing step, and carbonate ions or hydroxide ions as counter anions of the lithium compound will be discharged from the granular product in the form of carbon dioxide gas or steam. Therefore, the spaces where the lithium compound was present in the granular product would be voids, and lithium-containing composite oxide particles obtained after the firing were also ones having voids. Further, the spray-drying is carried out under such conditions that the solid content concentration of the slurry is low, and the viscosity is high, such being not desirable.

For example, in Patent Document 5, a slurry having a solid content concentration of 12.5 wt % and a viscosity of 290 mPa·s, is used. In Patent Document 6, a slurry having a solid content concentration of 12.5 wt % and a viscosity of from 190 to 1,510 mPa·s, is used. In Patent Document 7, a slurry having a solid content concentration of 15 wt % is used. In Patent Document 8, a slurry having a solid content concentration of 12 wt % and a viscosity of from 250 to 1,120 mPa·s is used. For the foregoing reasons, the lithium-containing composite oxides disclosed in Patent Documents 5 to 8 were not dense, whereby the packing density and volume capacity density were low, and they had no adequate performance.

It is an object of the present invention to provide a transition metal compound granule serving as a raw material useful to obtain a lithium-containing composite oxide for a positive electrode of a lithium secondary battery, which has high packing density, large volume capacity density and high safety and which is excellent in durability for charge and discharge cycles; a method for producing such a transition metal compound granule; a lithium-containing composite oxide produced by using such a transition metal compound granule; and a lithium secondary battery prepared by using such a lithium-containing composite oxide.

### Means to Accomplish the Object

The present inventors have conducted an extensive research and have found that in order to obtain a lithium-containing composite oxide for a positive electrode of a lithium secondary battery which has large volume capacity density and high safety and which is excellent in durability for charge and discharge cycles, a transition metal compound granule is necessary which comprises substantially spherical particles having an average particle size within an extremely small specific range and which has an average particle size D50 within a specific range and an average pore size within a specific range. Further, the present inventors have found it possible to obtain a transition metal compound granule useful for obtaining a lithium-containing composite oxide for a positive electrode of a lithium secondary battery, which has large volume capacity density and high safety and which is excellent in durability for charge and discharge cycles, by dispersing very small fine particles of a transition metal compound to prepare a slurry having high solid content concentration and low viscosity, and spray-drying such a slurry to granulate particles.

Thus, the present invention provides the following.

(1) A transition metal compound granule serving as a raw material for a positive electrode material for a lithium ion secondary battery, which comprises particles containing at least one element selected from the group consisting of nickel, cobalt and manganese and having an average particle size of the primary particles being at most 1 μm and which is substantially spherical and has an average particle size D50 of from 10 to 40 μm and an average pore size of at most 1 μm.
(2) The transition metal compound granule according to the above (1), which further contains at least one member selected from the group consisting of Ti, Zr, Hf, V, Nb, W, Ta, Mo, Sn, Zn, Mg, Ca, Ba and Al.
(3) The transition metal compound granule according to the above (1) or (2), which has a porosity of from 60 to 90%.
(4) The transition metal compound granule according to any one of the above (1) to (3), which has an aspect ratio of at most 1.20.
(5) The transition metal compound granule according to any one of the above (1) to (4), which has a repose angle of at most 60°.
(6) The transition metal compound granule according to any one of the above (1) to (5), wherein the proportion of hollow particles is at most 10%.
(7) The transition metal compound granule according to any one of the above (1) to (6), which has D10 of from 3 to 12 μm.
(8) The transition metal compound granule according to any one of the above (1) to (7), which has D90 of at most 70 μm.
(9) The transition metal compound granule according to any one of the above (1) to (8), which has a specific surface area of from 4 to 100 m²/g.
(10) The transition metal compound granule according to any one of the above (1) to (9), wherein the transition metal compound is at least one member selected from the group consisting of a hydroxide, an oxyhydroxide, an oxide and a carbonate.
(11) The transition metal compound granule according to any one of the above (1) to (10) wherein the transition metal compound is cobalt hydroxide or cobalt oxyhydroxide.
(12) A method for producing the transition metal compound granule as defined in any one of the above (1) to (11), which comprises spray-drying a slurry having dispersed in water particles which are transition metal compound particles containing at least one element selected from the group consisting of nickel, cobalt and manganese and which have a dispersed average particle size of at most 1 μm.
(13) The method for producing the transition metal compound granule according to the above (12), wherein the solid content concentration of the transition metal compound particles in the slurry is at least 35 wt %, and the viscosity of the slurry is from 2 to 500 mPa·s.
(14) The method for producing the transition metal compound granule according to the above (12) or (13), wherein the slurry further contains a compound containing at least one element selected from the group consisting of Ti, Zr, Hf, V, Nb, Ta, Mo, W, Zn, Mg, Ca, Sn, Ba and Al.
(15) The method for producing the transition metal compound granule according to any one of the above (12) to (14), wherein the transition metal compound particles dispersed in the slurry have a dispersed average particle size of at most 0.5 μm.
(16) The method for producing the transition metal compound granule according to any one of the above (12) to (15), wherein the transition metal compound particles dispersed in the slurry have D90 of at most 5 μm.
(17) The method for producing the transition metal compound granule according to any one of the above (12) to (16), wherein the slurry has a sedimentation degree of at least 0.8.
(18) The method for producing the transition metal compound granule according to the above (14), wherein the compound containing at least one element selected from the group consisting of Ti, Zr, Hf, V, Nb, Ta, Mo, W, Zn, Mg, Ca, Sn, Ba and Al, is contained as dissolved in the slurry, or such a compound is contained as dispersed in the form of particles.
(19) The method for producing the transition metal compound granule according to the above (14), wherein the slurry contains the compound containing at least one element selected from the group consisting of Ti, Zr, Hf, V, Nb, Ta, Mo, W, Zn, Mg, Ca, Sn, Ba and Al, as dispersed in the form of powder particles in the slurry.
(20) The method for producing the transition metal compound granule according to the above (19), wherein the dispersed average particle size of the powder particles dispersed in the slurry is at most twice the dispersed average particle size of the transition metal compound particles.
(21) The method for producing the transition metal compound granule according to any one of the above (12) to (20), wherein the slurry having the transition metal compound particles dispersed therein is a slurry obtained by precipitating and cleaning transition metal compound particles having a dispersed average particle size of at most 1 μm, and no pulverization step is included after the cleaning.
(22) The method for producing the transition metal compound granule according to any one of the above (12) to (21), wherein the transition metal compound is cobalt hydroxide, and the transition metal compound granule is a cobalt hydroxide granule.
(23) A lithium-containing composite oxide obtained by mixing the transition metal compound granule as defined in any one of the above (1) to (11), with a lithium compound, followed by firing.
(24) A lithium cobalt composite oxide obtained by mixing the transition metal compound granule obtained by the method as defined in the above (22), with a lithium compound, followed by firing in an oxygen-containing atmosphere at a firing temperature of from 1,000 to 1,100° C.
(25) A positive electrode for a lithium secondary battery, which comprises a cathode active material made of the lithium-containing composite oxide as defined in the above (23) or (24), an electroconductive material and a binder.
(26) A lithium ion secondary battery comprising a positive electrode, a negative electrode, a non-aqueous electrolyte and an electrolytic solution, wherein the positive electrode is the positive electrode for a lithium secondary battery as defined in the above (25).

### EFFECTS OF THE INVENTION

The present invention provides a transition metal compound granule serving as a raw material required to obtain a lithium-containing composite oxide such as a lithium cobalt composite oxide suitable for a cathode active material for a lithium secondary battery, which has high volume capacity density and high safety and which is excellent in durability for charge and discharge cycles, and a process for its production. Further, the present invention provides a lithium-containing composite oxide prepared by using such a transition metal compound granule, and a lithium secondary battery employing such a lithium-containing composite oxide.

The reason as to why a lithium-containing composite oxide having such effects can be obtained by using the transition metal compound granule of the present invention, is not necessarily clearly understood, but is considered to be as follows. That is, in order to produce an excellent lithium-containing composite oxide, it is necessary to prepare particles and powder to have a proper particle size and to be dense and have a high packing density. The present inventors have found that for such a purpose, it is necessary to use a raw material which has a proper particle size and which can be densely sintered, and by using such a raw material, it is possible to obtain particles and powder of a lithium-containing composite oxide, which has a suitable particle size and which is dense and has a high packing density. Accordingly, it is considered that in the present invention, by using a spherical transition metal compound granule which is prepared from transition metal compound particles having an extremely small primary particle size and which has a proper particle size, is substantially spherical and has a fine pore size, the reaction of the granule with the lithium compound which takes place during the firing, can be uniformly proceeded without irregularity, whereby irrespective of the interior or exterior of the granular particles, the particles are uniformly densely sintered as a whole. As a result, it is considered possible to obtain a lithium-containing composite oxide which has high volume capacity density and high safety and is excellent in durability for charge and discharge cycles and which is suitable for a positive electrode of a lithium secondary battery.

Further, the reason as to why it is possible to obtain a transition metal compound granule having the above-described effects by using the method of the present invention, is not necessarily clearly understood, but is considered to be as follows. That is, by spray-drying a slurry having high solid content concentration and low viscosity, prepared by dispersing very small transition metal compound particles, it is possible to form a transition metal compound granule which is spherical and has a fine pore size.

### BRIEF DESCRIPTION OF THE DRAWINGS

FIG. 1 is a SEM image obtained by photographing the cross section of particles of the cobalt hydroxide granule obtained in Example 1.

FIG. 2 is a SEM image obtained by photographing the cobalt hydroxide granule obtained in Example 1.

FIG. 3 is a SEM image obtained by photographing the cross section of particles of the lithium cobalt composite oxide obtained in Example 1.

### BEST MODE FOR CARRYING OUT THE INVENTION

The average pore size of the transition metal compound granule of the present invention is at most 1 μm. The lower limit of the average pore size is preferably 0.01 μm, more preferably 0.05 μm, particularly preferably 0.1 μm. On the other hand, the upper limit of the average pore size is preferably 0.8 μm, more preferably 0.5 μm, particularly preferably 0.3 μm. When the average pore size is within the above range, densification of the particles will proceed in the firing reaction, whereby it is possible to obtain a lithium-containing composite oxide having high packing density and high volume capacity density. If the above average pore size exceeds 1 μm, densification of particles will not proceed at the time of preparing the lithium-containing composite oxide, whereby the packing density of the lithium-containing composite oxide tends to be low, and the volume capacity density tends to be low, such being undesirable.

In the present invention, the average pore size means a numerical value of the pore size corresponding to one half of the accumulated pore volume in the measurement of the pore size distribution by injecting mercury under a pressure of from 0.1 kPa to 400 MPa by a mercury injection method by a mercury porosimeter.

Further, in the present invention, the average particle size of primary particles which form the transition metal compound granule can be obtained by observation by a scanning electron microscope (which may be referred to as SEM in the present invention). It is more preferred to employ a super high resolution field emission scanning electron microscope (which may be referred to as FE-SEM in the present invention), since it is thereby possible to obtain a higher resolution image. It can be obtained by observing the surface of the transition metal compound granule by SEM, or by embedding the transition metal compound granule in a thermosetting resin such as an epoxy resin, followed by polishing, and observing the cross section of the polished particles by SEM. With respect to the magnification of SEM, a magnification suitable for the observation may be selected depending upon the particle size of primary particles, but it is preferred to employ an image as observed at from 10,000 to 50,000-fold magnification. From the observed image, at least 50 particles may be measured by means of an image analysis software (e.g. image analysis software Macview ver3.5, manufactured by Mountech Co., Ltd.), and based on their circle-equivalent diameters, an average particle size of primary particles is obtainable.

In the present invention, the average particle size of primary particles forming the transition metal compound granule is at most 1 μm, preferably at most 0.5 μm, more preferably at most 0.3 μm. Further, the average particle size is preferably at least 0.01 μm, more preferably at least 0.03 μm, further preferably at least 0.05 μm. When the average particle size is within such a range, it is possible to obtain a lithium-containing composite oxide which is dense and has high packing density and volume capacity density. If the average particle size exceeds 1 μm, the packing density and volume capacity density of the lithium-containing composite oxide obtainable from such a transition metal compound granule tend to be low.

Further, in the present invention, the average particle size D50 of the transition metal compound granule is from 10 to 40 μm. If the average particle size D50 is smaller than 10 μm, the particle size of the synthesized lithium-containing composite oxide tends to be small, and the packing density tends to be low. If the average particle size D50 is larger than 40 μm, at the time of coating a current collector with the cathode active material in the electrode processing step, coating cannot be carried out uniformly, or the cathode active material is likely to be peeled from the current collector, whereby coating of the current collector such as an aluminum foil tends to be difficult. Here, the upper limit of the average particle size D50 is more preferably 35 μm, further preferably 30 μm.

Here, in the present invention, the average particle size D50 means an accumulative 50% value in a volume-based particle size distribution obtained by a laser scattering particle size distribution measuring apparatus (e.g. Microtrac HRAX-100, manufactured by NIKKISO CO., LTD.). Further, the after-mentioned D10 means an accumulative 10% value, and D90 means an accumulative 90% value. Here, as the solvent, it is necessary to select a solvent wherein the granule will not be dissolved or will not be re-dispersed. In the present invention, acetone was used as the solvent.

Further, with respect to the particle size distribution of the transition metal compound granule of the present invention, D10 is preferably from 3 to 13 μm, more preferably from 5 to 11 μm. When D10 is within this range, the transition metal compound granule can maintain its shape, and becomes a lithium-containing composite oxide having a particle size distribution suitable for packing, whereby it is possible to obtain a lithium-containing composite oxide having high packing density and volume capacity density, such being desirable. If D10 is smaller than 3 μm, a plurality of small particles are likely to be collected and sintered to have a deformed shape, whereby the packing density of the lithium-containing composite oxide tends to be low, such being undesirable. On the other hand, if D10 exceeds 13 μm, small particles will be little in the particle size distribution of the lithium-containing composite oxide, whereby the packing density tends to be low, such being undesirable.

Further, with respect to the particle size distribution of the transition metal compound granule of the present invention, D90 is preferably at most 70 μm, more preferably at most 60 μm, further preferably at most 50 μm. When D90 is at most 70 μm, coating of the electrode can easily be conducted. However, if D90 exceeds 70 μm, at the time of coating a current collector with the cathode active material in the electrode-processing step, uniform coating tends to be difficult, or the cathode active material is likely to be peeled from the current collector, whereby coating of a current collector such as an aluminum foil tends to be difficult.

The transition metal compound granule obtained by the present invention contains at least one element selected from the group consisting of nickel, cobalt and manganese. Particularly, from the practical viewpoint, it preferably contains cobalt, nickel, a combination of cobalt and nickel, a combination of manganese and nickel, or a combination of nickel, cobalt and manganese, more preferably cobalt or a combination of nickel, cobalt and manganese, particularly preferably cobalt alone.

Further, in the transition metal compound granule, a metal element other than nickel, cobalt and manganese may be contained, and specifically, it is preferably at least one element (which may be referred to as an additive element in the present invention) selected from the group consisting of titanium, zirconium, hafnium, vanadium, niobium, tungsten, tantalum, molybdenum, tin, zinc, magnesium, calcium, barium and aluminum, more preferably at least one element selected from the group consisting of titanium, zirconium, niobium, magnesium and aluminum. The amount of the additive element is preferably at least 0.001 mol %, more preferably at least 0.005 mol %, based on the total amount of nickel, cobalt and manganese. On the other hand, the upper limit is preferably 5 mol %, more preferably 4 mol %.

In the present invention, the transition metal compound granule has a high porosity. The porosity is preferably at least 60%, more preferably at least 65%, further preferably at least 70%. Here, the upper limit is preferably 90%, more preferably 85%. When the porosity is high, lithium atoms are likely to readily penetrate into the granule, whereby the reaction can be proceeded uniformly, and it is possible to obtain a lithium-containing composite oxide, of which the entire particles are dense. However, if the porosity is too high, the transition metal compound granule tends to be bulky, whereby the handling tends to be difficult. On the other hand, if the porosity is as low as less than 60%, voids in the particles tend to be little, whereby the reaction tends to be non-uniform as between the surface and the interior at the time of synthesizing the lithium-containing composite oxide, and the densification of particles tends not to proceed uniformly, whereby the packing density of the lithium-containing composite oxide tends to be low, and the volume capacity density tends to be low. In the present invention, the porosity can be measured by a mercury injection method by means of a mercury porosimeter and can be obtained by injecting mercury under a pressure of from 0.1 kPa to 400 MPa.

In the present invention, the transition metal compound granule is substantially spherical. “Substantially spherical” means that it has high sphericity and is not necessarily required to be perfectly spherical. Accordingly, the aspect ratio is preferably at most 1.20, more preferably at most 1.15, particularly preferably at most 1.10. Here, the lower limit is preferably 1. If the aspect ratio is outside the above range, the prepared lithium-containing composite oxide tends to have poor sphericity, low packing density and low volume capacity density. In the present invention, the aspect ratio can be obtained by photographic observation by SEM. Specifically, the transition metal granule is embedded in an epoxy thermosetting resin, then cutting the particles, and then the cut cross section is polished, and the cross section of the particles is observed. The cross section of from 100 to 300 granular particles is measured by SEM at 500-fold magnification. At that time, all particles in the image will be objects for measurement of particle sizes. The aspect ratio is a value obtained by dividing the longest diameter of each particle by the diameter vertical to the longest diameter, and an average value thereof is the aspect ratio in the present invention. In the present invention, the aspect ratio was measured by using image analysis software Macview ver3.5, manufactured by Mountech Co., Ltd.

Also from a SEM image having the transition metal compound granule photographed by a scanning electron microscope, it can be confirmed that the transition metal compound granule obtained by the method of the present invention has high sphericity and small average pore size. Further, from a SEM image of particles of the lithium-containing composite oxide or from a SEM image obtained by photographing the cross section of particles of a lithium-containing composite oxide, it can be confirmed that the lithium-containing composite oxide obtainable by using as a raw material the transition metal compound granule of the present invention, has very high sphericity and high packing density. A SEM image of the cross section of particles can be photographed as follows. Firstly, particles to be measured are embedded in an epoxy thermosetting resin, then the particles are cut, and then the cut cross section is polished, whereupon the cross section of the particles are photographed to obtain a SEM image of the cross section of the particles.

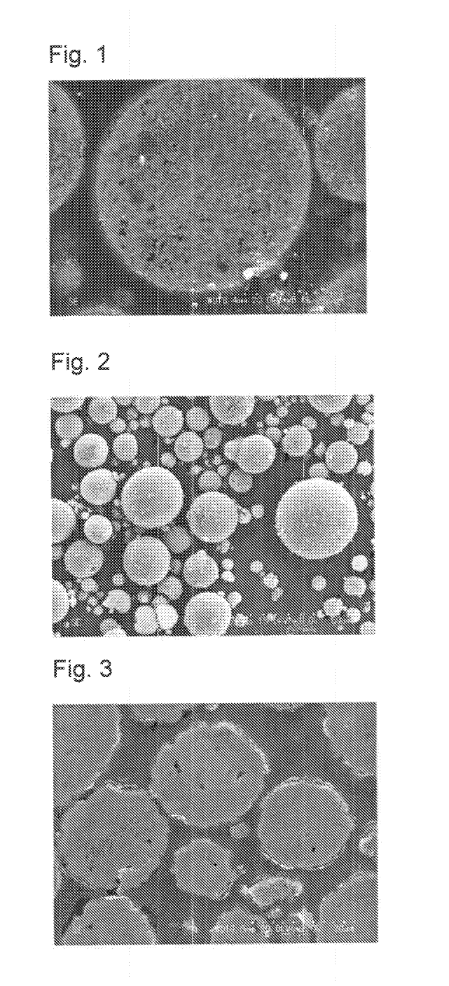

Further, from FIG. 1 which is a photograph having the cross section of the transition metal compound granule of the present invention photographed by means of SEM, it is observed that the granular particles of the present invention are particles which have very high sphericity and high porosity with fine spaces present among primary particles. Also from FIG. 2 which is a photograph having particles of the transition metal compound granule of the present invention photographed by SEM, it is also possible to confirm such high sphericity. Further, from FIG. 3 which is a photograph obtained by photographing by SEM the cross section of a lithium-containing composite oxide produced by using the transition metal compound granule as a raw material, it is observed that the sphericity is very high and it is possible to obtain particles which are well sintered by firing and which are dense and have high density.

Further, the transition metal compound granule in the present invention has high flowability and a repose angle of preferably at most 60°, more preferably at most 55°, further preferably at most 50°. If the repose angle exceeds 60°, the lithium-containing composite oxide tends to have low packing density or low volume capacity density. On the other hand, the lower limit of the repose angle is preferably 30°, more preferably 40°. When the repose angle of the granule is within the above range, a lithium-containing composite oxide prepared from the transition metal compound granule having high flowability, has high packing density and volume capacity density, such being desirable.

Further, the transition metal compound granule in the present invention contains little hollow particles, and the content of hollow particles is preferably at most 10%, more preferably at most 5%, further preferably at most 1%, particularly preferably 0%, of all particles. Hollow particles are formed during spray drying when the exterior of granular particles will dry first and heated air or steam will remain trapped in the interior of granular particles, and such hollow particles will create voids in the interior of the lithium-containing composite oxide, whereby the packing density and volume capacity density tend to be low, such being undesirable, and if their content is outside the above range, the decrease of the volume capacity density tends to be remarkable. When the content is within the above range, their influence is little, and an excellent volume capacity density can be obtained. Here, in the present invention, the content of hollow particles can be determined by photographic observation by SEM. Specifically, the transition metal compound granule is embedded in an epoxy thermosetting resin, then the particles are cut, and then the cut cross section is polished, whereupon the cross section of the particles is observed. The cross section of randomly selected 100 granular particles having the longest diameter of at least 5 μm is observed by SEM at 1,000-fold magnification, whereby the number of hollow particles is counted. In a case where a void having a longest diameter of at least 1 μm is observed in a particle or on its surface, such a particle is counted as a hollow particle.

The transition metal compound granule of the present invention has a bulk density of preferably at least 0.2 g/cm³, more preferably at least 0.3 g/cm³, particularly preferably at least 0.4 g/cm³. If the bulk density is lower, the powder tends to be bulky, whereby the productivity tends to be low when it is mixed with a lithium compound and fired, such being undesirable. On the other hand, the upper limit is preferably 1.5 g/cm³, more preferably 1.2 g/cm³, particularly preferably 1.0 g/cm³. If the bulk density is higher than such a range, the particles tend to be hardly densely sintered by firing, such being undesirable. Further, the tap density of the transition metal compound granule is preferably at least 0.4 g/cm³, more preferably at least 0.5 g/cm³, particularly preferably at least 0.6 g/cm³. The upper limit is preferably 2 g/cm³, more preferably 1.5 g/cm³, particularly preferably 1.2 g/cm³. When the tap density is within such a range, the reaction proceeds uniformly at the time of preparing a lithium-containing composite oxide by firing its mixture with a lithium compound, such being desirable. Here, in the present invention, the bulk density and the tap density can be obtained by using “Tap Denser KYT-4000” manufactured by SEISHIN ENTERPRISE CO., LTD. and introducing the powder to a 20 ml cylinder through a sieve having apertures of 710 μm, whereupon the bulk density is calculated from the weight of the introduced powder and the volume of the cylinder. Further, the cylinder is tapped 700 times with a clearance of 20 mm, whereby a tap density is calculated from the volume and weight of the powder.

Further, the specific surface area of the transition metal compound granule of the present invention is preferably from 4 to 100 m²/g, more preferably from 8 to 80 m²/g, further preferably from 10 to 60 m²/g. When the specific surface area is within this range, the synthesis reaction for a lithium-containing composite oxide will take place uniformly and it is possible to obtain a lithium-containing composite oxide which is dense and has high packing density and volume capacity density. If the specific surface area is smaller than 4 m²/g, the reactivity in the synthesis reaction tends to be poor, it becomes difficult to obtain a dense lithium-containing composite oxide, and the packing density and volume capacity density tend to be low, such being undesirable. If the specific surface is larger than 100 m²/g, the reactivity in the synthesis reaction tends to be too high, it becomes difficult to let the reaction proceed uniformly, and a lithium-composite oxide which has a deformed shape and which has low packing density and volume capacity density is likely to be obtained, such being undesirable. Here, in the present invention, the specific surface area is obtained by BET method.

The method for producing a transition metal compound granule of the present invention is not particularly limited. However, it is preferably obtained by spray drying a slurry obtained by dispersing transition metal compound particles. In such a case, the dispersed average particle size of transition metal compound particles dispersed in the slurry is at most 1 μm, preferably at most 0.5 μm, further preferably at most 0.3 μm. On the other hand, the dispersed average particle size is preferably at least 0.01 μm, more preferably at least 0.03 μm, further preferably at least 0.05 μm. If the dispersed average particle size is larger than 1 μm, large voids will be formed in the interior of the granular particles obtained by the spray drying, and further, the packing density and volume capacity density of a lithium-containing composite oxide obtained from such a granule tend to be low, and if the dispersed average particle size is too small, the viscosity of the slurry tends to be high.

In the present invention, the dispersed average particle size of the slurry means an accumulative 50% value in the volume particle size distribution obtained by a laser scattering particle size distribution measuring apparatus (e.g. LA-920, manufactured by Horiba, Ltd.). The measurement is carried out by diluting the slurry to a concentration measurable by the laser scattering particle size distribution measuring apparatus.

Further, by using a powder having a relatively weak cohesive force as the transition metal compound particles serving as a raw material for the transition metal compound granule of the present invention, it is possible to prepare a slurry which has a small dispersed average particle size, a low viscosity and a high solid content concentration. By using such a raw material, it is possible to readily obtain a transition metal compound granule powder having the construction as defined by the present invention such as the average particle size.

Further, D90 of fine particles of the transition metal compound dispersed in the slurry can be obtained by a laser scattering particle size distribution meter in the same manner as for the dispersed average particle size, and it means a particle size at a point where the accumulative curve becomes 90%. This D90 represents the size and amount of coarse particles in the slurry and should better be small, whereby it is possible to form a transition metal compound granule which can be densely sintered. This D90 is preferably at most 5 μm, more preferably at most 4 μm, further preferably at most 3 μm. On the other hand, the lower limit of D90 is preferably 0.5 μm, more preferably 1 μm. If this D90 is larger than 5 μm, large voids will be formed in the granule, or the particles tend to be hardly densely sintered, whereby the packing density of the resulting lithium-containing composite oxide tends to be low.

In the present invention, the dispersion medium for the slurry is not particularly limited so long as it is a liquid. However, it is preferably an aqueous system, whereby the production cost is low, and the load on the environment is little. In the present invention, the aqueous system may contain an organic solvent or the like, and it means a system wherein preferably at least 80 vol %, more preferably at least 90 vol %, further preferably at least 95 vol %, of the dispersion medium is water. With respect to the upper limit, it is preferably a system containing no organic solvent i.e. wherein 100 vol % of the dispersion medium is water, from the viewpoint of the environmental load.

Further, by using a powder having a relatively weak cohesive force as the transition metal compound particles serving as a raw material for the transition metal compound granule of the present invention, it is possible to prepare a slurry which has a small dispersed average particle size, a low viscosity and a high solid content concentration. By using such a raw material, it is possible to readily obtain a transition metal compound granule powder which has high sphericity and high packing density.

In the present invention, the solid content concentration of the slurry is at least 35 wt %, preferably at least 40 wt %, more preferably at least 45 wt %. Further, the solid content concentration of the slurry is preferably at most 80 wt %, more preferably at most 70 wt %, further preferably at most 60 wt %. When the solid content concentration of the slurry is at least 35 wt %, the size of liquid droplets to be sprayed can be adjusted, and the particle size of the transition metal compound granule can be easily adjusted. Further, in the interior of the granule, fine particles will be uniformly distributed without being roughly or densely disproportionated. Further, as the solid content concentration becomes high, the productivity and production efficiency tend to be high, and the water content in the slurry becomes small, whereby the energy required for drying will be small for the spray drying, such being desirable. If the solid content concentration is less than 35 wt %, the particle size tends to be hardly enlarged, and voids in the granule tend to increase, whereby it tends to be difficult to obtain a lithium-containing composite oxide which has high packing property and volume capacity density. Further, the productivity tends to be low, and the energy required to remove the solvent at the time of the spray drying tends to increase.

In the present invention, the lower limit of the viscosity of the slurry is 2 mPa·s, preferably 4 mPa·s, more preferably 6 mPa·s. On the other hand, the upper limit of the viscosity of the slurry is 500 mPa·s, preferably 400 mPa·s, more preferably 300 mPa·s, further preferably 100 mPa·s. If the viscosity is lower than 2 mPa·s, the solid content concentration of the slurry tends to be low, or the particle size of the dispersed transition metal compound fine particles tend to be large, whereby it tends to be difficult to obtain a spherical uniform granule, such being undesirable. If the viscosity is higher than 500 mPa·s, the fluidity of the slurry tends to be poor, whereby transportation of the solution or the transportation to a nozzle for a spray dryer tends to be difficult, or the nozzle is likely to be clogged to hinder spraying, such being undesirable. Especially with a slurry having a high solid content concentration of at least 35 wt % and having a high viscosity, a phenomenon of clogging of the nozzle to hinder spraying tends to be remarkable. The viscosity of the slurry is usually measured by a rotary viscometer or a vibration viscometer, and the value may change substantially depending upon the type of the viscometer or the measuring conditions. In the present invention, it is measured by using a small amount of sample unit by a digital rotary viscometer DV-II+LV model, manufactured by Brookfield at 25° C. under a condition of 30 rpm, whereby in a case where the viscosity is at most 100 mPa·s, spindle No. 18 is employed, and in the case of at least 100 mPa·s, spindle No. 31 is employed for the measurement.

A dispersant may be added to the slurry in order to increase the solid content concentration and to lower the viscosity. As such a dispersant, a common dispersant such as a polycarboxylic acid type polymer surfactant, an ammonium salt of a polycarboxylic acid type polymer surfactant or a polyacrylate, may be used.

In a case where a dispersant is added to the slurry having various raw materials dispersed, if a large amount of the dispersant is added, the viscosity of the slurry may be increased, and by the influence of the added dispersant, a dense lithium-containing composite oxide may not be obtained. Therefore, when a dispersant is to be added, it is advisable that a proper amount of the dispersant is added.

In order to carry out spraying under a stabilized condition, it is preferred that the transition metal compound particles dispersed in the slurry are suspended for a long time without sedimentation. With respect to the sedimentation, the slurry is put in a 500 ml measuring cylinder and left to stand still at a constant temperature (25° C.) for 1 week to let the slurry separate into a supernatant layer and a slurry layer containing the particles, and the ratio of the volume of the slurry layer containing the particles to the total amount of the slurry is taken as the sedimentation degree. Such a sedimentation degree is preferably at least 0.8, more preferably at least 0.85, further preferably at least 0.90. Within such a range, a uniform slurry can be sprayed under a stabilized condition, whereby the particle size, shape, pore distribution, etc. of the transition metal granule thereby obtained, are stabilized, and a uniformly sintered dense lithium-containing composite oxide can be obtained without rough or dense disproportionation of fine particles in the inside of the particles, such being desirable. On the other hand, if the sedimentation degree is less than 0.8, spraying of the slurry will be unstable, whereby it tends to be difficult to obtain a granule having uniform physical properties, and consequently, it tends to be difficult to obtain a uniformly sintered dense lithium-containing composite oxide.

In the spray drying of the slurry containing the transition metal compound particles, it is possible to employ a spray drying apparatus wherein a disk is rotated at a high speed to prepare liquid droplets thereby to carry out drying, or a spray drying apparatus wherein the slurry is sprayed to prepare liquid droplets thereby to carry out drying by using e.g. a two-fluid nozzle or a four-fluid nozzle. Further, an optional particle size can be obtained by adjusting the operation conditions of the respective apparatus. The spray dryer is not particularly limited, but a spray dryer employing a four-fluid nozzle is particularly preferred, since it is thereby possible to easily adjust the particle size by adjusting the spray air amount.

The transition metal compound granule of the present invention is preferably at least one member selected from the group consisting of a hydroxide, an oxyhydroxide, an oxide and a carbonate of the transition metal compound, more preferably either one of the hydroxide and the oxyhydroxide, further preferably the hydroxide. The transition metal element source serving as a raw material of the transition metal compound granule is not particularly limited so long as it is a compound containing the transition metal. However, the following compounds are preferred as the transition metal element source serving as a raw material. Namely, in a case where the transition metal compound granule contains cobalt, it is preferred to use as the cobalt source at least one member selected from cobalt hydroxide, cobalt oxyhydroxide, cobalt oxide and cobalt carbonate. Among them, cobalt hydroxide is particularly preferred, since fine particles having sufficiently fine particle size can be prepared simply by crystal precipitation by dropping an alkali to an aqueous solution having cobalt dissolved, and since it is inexpensive.

Further, in a case where the transition metal compound granule contains nickel, it is preferred to use as the nickel source, at least one member selected from nickel hydroxide, nickel oxyhydroxide, nickel oxide and nickel carbonate. In a case where the transition metal compound granule contains manganese, it is preferred to use manganese oxide as the manganese source. In a case where a transition metal compound granule containing a plurality of transition metal elements is to be produced, hydroxides, oxyhydroxides, oxides, and carbonates of the respective elements may respectively be used as mixed.

Further, in a case where a coprecipitated compound containing at least two types of elements such as nickel/cobalt, nickel/manganese, cobalt/manganese or nickel/cobalt/manganese, is used as a raw material, a plurality of transition metal atoms can be easily uniformly mixed. Therefore, it is preferred to use any one of a coprecipitated hydroxide, a coprecipitated oxyhydroxide, a coprecipitated oxide and a coprecipitated carbonate, more preferably a coprecipitated hydroxide which can be prepared easily and at a low cost. In the present invention, a compound containing nickel, cobalt and manganese may be represented by a nickel/cobalt/manganese compound or a Ni—Co—Mn compound.

Further, a transition metal compound granule containing an additive element may be obtained by incorporating such an element to the transition metal compound particles by a coprecipitation method. As another method, a transition metal compound granule containing an additive element can be obtained by adding a solution having the additive element dissolved to a slurry having transition metal compound particles dispersed, followed by uniform mixing and then by granulation.

Further, as another method, a transition metal compound granule containing an additive element can be obtained also by uniformly mixing and dispersing transition metal compound particles and a compound containing the additive element to prepare a slurry containing the transition metal compound particles and the compound containing the additive element, and spray-drying such a slurry. It is particular preferred to employ a coprecipitation method which is a method capable of uniformly mixing atoms at an atomic level. Further, in a case where preference is placed on costs or productivity, a method of adding the additive element in the form of solid powder particles, is preferred, since it is thereby possible to omit a step of dissolving or a step of coprecipitating the additive element. By a method of dissolving the additive element in a solution, followed by mixing, it is possible to add the additive element at lower cost and higher productivity than the coprecipitation method and at a higher uniformity than a case where it is added as powder particles.

In a case where the additive element is added in the form of powder particles, its dispersed average particle size is preferably at most two times, more preferably at most 1.5 times, further preferably at most 1 time the dispersed average particle size of the transition metal compound particles. In such a case, the difference in the particles size to the transition metal compound particles in the granule is small, and it becomes possible to obtain a transition metal compound granule having the additive element uniformly dispersed in the granular particles, and it is possible to obtain a lithium-containing composite oxide which is uniformly and densely sintered. If it is larger than two times, it cannot be uniformly dispersed in the granular particles, or voids are likely to be formed in the granular particles, whereby it becomes difficult to obtain a uniform transition metal compound granule, and it becomes difficult to obtain a lithium-containing composite oxide which is uniformly and densely sintered, such being undesirable. Further, in a case where the additive element is added in the form of powder particles, its dispersed average particle size is preferably at least 0.03 time, more preferably at least 0.1 time, the dispersed average particle size of the transition metal compound particles.

The transition metal compound granule of the present invention and a lithium compound are mixed and fired, followed by pulverization to obtain a lithium-containing composite oxide useful as a positive electrode material for a lithium secondary battery, which has high safety and which is excellent in durability for charge and discharge cycles. Especially when a mixture of a cobalt hydroxide granule and a lithium compound is to be fired, firing is carried out in an oxygen-containing atmosphere at a firing temperature of from 1,000 to 1,100° C., more preferably from 1,010 to 1,080° C., particularly preferably from 1,030 to 1,070° C. Within such a range, the cobalt hydroxide granule can be uniformly sintered, and it is possible to obtain a lithium cobalt composite oxide which is spherical and dense and has high volume capacity density, such being desirable. If the firing temperature is higher than 1,100° C., the lithium cobalt composite oxide is likely to be decomposed, and a plurality of particles are bonded to form lithium cobalt composite oxide particles having a deformed shape, whereby the volume capacity density is likely to be low, such being undesirable.

In a case where the transition metal is composed mainly of cobalt, the lithium-containing composite oxide of the present invention has a press density of preferably from 3.2 to 3.6 g/cm³, particularly preferably from 3.3 to 3.5 g/cm³. Here, the press density in the present invention means an apparent press density when 5 g of particle powder is compressed under a pressure of 0.32 t/cm².

A method for obtaining a positive electrode of a lithium secondary battery by using the lithium-containing composite oxide of the present invention, can be carried out in accordance with a usual method. For example, a powder of a cathode active material of the present invention is mixed with a carbon type electroconductive material such as acetylene black, graphite or Ketjenblack and a binder to form a positive electrode mixture. As the binder, polyvinylidene fluoride, polytetrafluoroethylene, polyamide, carboxy methylcellulose or an acrylic resin may, for example, be used.

Such a positive electrode mixture is dispersed in a dispersing medium such as N-methylpyrrolidone to obtain a slurry, which is applied, dried and press-rolled on a positive electrode current collector such as an aluminum foil to form a cathode active material layer on the positive electrode current collector.

In a lithium secondary battery wherein the cathode active material of the present invention is used as a positive electrode, as a solute of the electrolytic solution, it is preferred to use at least one member of lithium salts wherein e.g. ClO₄⁻, CF₃SO₃⁻, BF₄⁻, PF₆⁻, AsF₆⁻, SbF₆⁻, CF₃CO₂⁻ or (CF₃SO₂)₂N⁻ is contained as an anion. For such an electrolytic solution or polymer electrolyte, it is preferred to add an electrolyte made of a lithium salt in the above-mentioned solvent or solvent-containing polymer at a concentration of from 0.2 to 2.0 mol/L. If the concentration is outside this range, the ion conductivity tends to be low, and the electrical conductivity of the electrolyte tends to be low. More preferably, from 0.5 to 1.5 mol/L is selected. For a separator, a porous polyethylene or porous polypropylene film is used.

As a solvent for the electrolytic solution, a carbonate ester is preferred. The carbonate ester may be cyclic or linear. A cyclic carbonate ester may, for example, be propylene carbonate or ethylene carbonate (EC). A linear carbonate ester may, for example, be dimethyl carbonate, diethyl carbonate (DEC), ethylmethyl carbonate, methylpropyl carbonate or methylisopropyl carbonate.

Such carbonate esters may be used alone or in combination as a mixture of two or more of them. Further, such a carbonate ester may be used as mixed with another solvent. Further, depending upon the material of the anode active material, the linear carbonate ester and the cyclic carbonate ester may be used in combination, whereby the discharge properties, the cycle durability or the charge and discharge efficiency may sometimes be improved.

Further, to such an organic solvent, a vinylidene fluoride-hexafluoropropylene copolymer (e.g. KYNAR, manufactured by Atochem) or a vinylidene fluoride-perfluoropropylvinyl ether copolymer may be added, and the following solute may be added, to form a gel polymer electrolyte.

An anode active material for a lithium battery wherein the cathode active material of the present invention is used as a positive electrode, is a material capable of occluding or discharging lithium ions. A material to form such an anode active material is not particularly limited, and for example, lithium metal, a lithium alloy, a carbon material, a carbon compound, a silicon carbide compound, a silicon oxide compound, titanium sulfide, a boron carbonate compound, or an oxide composed mainly of a metal of Group 14 or 15 in the Periodic Table may be mentioned.

As the carbon material, one having an organic material thermally decomposed under various thermal decomposition conditions, artificial graphite, natural graphite, soil graphite, exfoliated graphite or flake graphite may, for example, be used. Further, as the oxide, a compound composed mainly of tin oxide may be used. As a negative electrode current collector, a copper foil or a nickel foil may, for example, be used.

The shape of the lithium secondary battery in which the cathode active material of the present invention is used, is not particularly limited. The shape is selected from a sheet-shape (so-called film-shape), a folded shape, a wound cylinder with bottom, a button shape, etc. depending upon the particular purpose.

### EXAMPLES

Now, the present invention will be described in detail with reference to Examples, but it should be understood that the present invention is by no means restricted to such specific Examples.

### Example 1

### Present Invention

In 30 kg of water, 20 kg of cobalt hydroxide particles were dispersed. The cobalt hydroxide particles dispersed in such a slurry had a dispersed average particle size of 0.3 μm and D90 of 0.55 μm, and the viscosity of the slurry was 9 mPa·s. Here, in the present invention, the viscosity of the slurry can be obtained by measuring it by using a digital rotary viscometer DV-II+LV model manufactured by Brookfield and spindle No. 18 at 25° C. under a condition of 30 rpm. Further, the slurry was sampled, dried at 100° C. and measured, whereby the solid content concentration was 40 wt %. Further, the slurry was sampled, put into a 500 ml measuring cylinder, covered and left to stand still at 25° C. for 1 week, whereupon it was separated into a liquid layer containing a powder and a supernatant layer. At that time, the ratio of the liquid layer containing the powder to the entire liquid amount was measured as a sedimentation degree, and the sedimentation degree was 0.95. This slurry was subjected to spray drying by using a spray dryer (MDP-050, manufactured by Fujisaki Electric). The spray drying was carried out at an inlet temperature of the drying chamber being 200° C., at an air flow rate of 500 L/min and a liquid supply amount of 500 ml/min to obtain a cobalt hydroxide granule.

With respect to the obtained granule, the particle size distribution was measured in an acetone solvent by a laser diffraction type particle size distribution meter (Microtrac HRAX-100, manufactured by NIKKISO CO., LTD.), whereby the granule had an average particle size D50 of 21.9 μm, D10 of 7.6 μm and D90 of 35.8 μm. By using a mercury porosimeter, the average pore size and porosity of the granule were measured, whereby the average pore size was 0.12 μm, and the porosity was 79%. The granule had a specific surface area of 22.2 m²/g, a repose angle of 48°, a bulk density of 0.6 g/cm³, a tap density of 0.8 g/cm³ and a cobalt content of 61.9 wt %.

Further, the granule was embedded in an epoxy thermosetting resin, cut and subjected to polishing treatment, whereupon a photograph of the cross section of particles was taken by SEM. By means of an image analysis software, the particle shape of the cross section of particles was observed, whereby the average particle size of primary particles was 0.3 μm, and the aspect ratio of granular particles was 1.08. Further, the content of hollow particles was counted and found to be 0%.

146.1 g of this cobalt hydroxide granule and 56.6 g of lithium carbonate having a lithium content of 18.7 wt %, were mixed and fired at 1,030° C. for 14 hours, followed by pulverization to obtain a powder of a lithium cobalt composite oxide represented by a composition of LiCoO₂ (which may simply be represented by LiCoO₂ in the present invention). The particle size distribution of this LiCoO₂ was measured in a water solvent by using a laser scattering particle size distribution measuring apparatus, whereby the average particle size D50 was 17.5 μm, D10 was 8.0 μm, and D90 was 27.3 μm. Further, the specific surface area was 0.38 m²/g, and the press density was 3.34 g/cm³.

Further, the powder of this LiCoO₂, acetylene black and a polyvinylidene fluoride powder were mixed in a weight ratio of 90/5/5, and further, N-methylpyrrolidone was added to prepare a slurry, which was applied on one side of an aluminum foil having a thickness of 20 μm by means of a doctor blade. The slurry applied on the aluminum foil was dried, followed by press rolling five time to prepare a positive electrode sheet for a lithium battery. Then, a simplified sealed cell type lithium battery made of stainless steel was assembled in an argon glove box, using one punched out from the above positive electrode sheet as a positive electrode, a metal lithium foil having a thickness of 500 μm as a negative electrode, a nickel foil of 20 μm as a negative electrode current collector, porous polypropylene having a thickness of 25 μm as a separator and an LiPF₆/EC+DEC (1:1) solution (which means a mixed solution of EC and DEC in a weight ratio (1:1) whose solute is LiPF₆; the same applies also to solvents mentioned hereinafter) at a concentration of 1M as an electrolyte.

With respect to the above battery, an initial discharge capacity was obtained by charging up to 4.3 V at a load current of 75 mA per 1 g of the cathode active material at 25° C. and discharging down to 2.5 V at a load current of 75 mA per 1 g of the cathode active material. Further, with respect to this battery, the charge and discharge cycle test was sequentially carried out 30 times. As a result, the discharge capacity at 25° C. between 2.5 and 4.3 V was 161 mAh/g, and the capacity retention after the charge and discharge cycle test of 30 times was 95.7%. Further, the volume capacity density was 538 mAh/cm³. Here, the volume capacity density is one obtained by multiplying the press density by the value of the discharge capacity.

Further, another battery was prepared in the same manner. This battery was charged at 4.3 V for 10 hours and then disassembled in an argon glove box, and the positive electrode sheet after the charging was taken out. The positive electrode sheet was cleaned, then punched to have a diameter of 3 mm, sealed in an aluminum capsule together with EC and heated at a rate of 5° C./min by a differential scanning calorimeter, whereby the exothermic onset temperature was measured. As a result, the exothermic onset temperature of the 4.3 V-charged product was 162° C.

### Example 2

### Present Invention

A slurry was prepared in the same manner as in Example 1 except that 20 kg of cobalt hydroxide particles were dispersed in 37.1 kg of water. The cobalt hydroxide particles dispersed in the slurry had a dispersed average particle size of 0.3 μm and D90 of 0.50 μm. The slurry had a viscosity of 6 mPa·s, a solid content concentration of 35 wt % and a sedimentation degree of 0.92. Further, a cobalt hydroxide granule was obtained in the same manner as in Example 1 except that the air flow rate was changed to 400 L/min. The obtained granule had an average particle size D50 of 27.4 μm, D10 of 9.0 μm and D90 of 50.9 μm. The average pore size was 0.14 μm, and the porosity was 81%. The granule had a specific surface area of 22.5 m²/g, a repose angle of 51°, a bulk density of 0.6 g/cm³, a tap density of 0.8 g/cm³, a cobalt content of 62.2 wt %, an average particle size of primary particles being 0.3 μm and an aspect ratio of granular particles being 1.06, and a content of hollow particles being 0%.

145.3 g of this cobalt hydroxide granule and 56.6 g of lithium carbonate having a lithium content of 18.7 wt %, were mixed and fired at 1,030° C. for 14 hours, followed by pulverization to obtain a powder of LiCoO₂. This LiCoO₂ had an average particle size D50 of 19.2 μm, D10 of 8.3 μm, D90 of 33.8 μm, a specific surface area of 0.40 m²/g and a press density of 3.38 g/cm³. The initial discharge capacity was 161 mAh/g, the capacity retention after the charge and discharge cycle test of 30 times was 97.8%, and the volume capacity density was 544 mAh/cm³. Further, the exothermic onset temperature was 162° C.

### Example 3

### Present Invention

A slurry was prepared in the same manner as in Example 1 except that 20 kg of cobalt hydroxide particles were dispersed in 24.4 kg of water. The cobalt hydroxide particles dispersed in the slurry had a dispersed average particle size of 0.4 μm and D90 of 0.72 μm. The slurry had a viscosity of 13 mPa·s, a solid content concentration of 45 wt % and a sedimentation degree of 0.98. Further, a cobalt hydroxide granule was obtained in the same manner as in Example 1. The obtained granule had an average particle size D50 of 30.7 μm, D10 of 13.1 μm and D90 of 53.4 μm. The average pore size was 0.16 μm, and the porosity was 76%. The granule had a specific surface area of 25.2 m²/g, a repose angle of 48°, a bulk density of 0.6 g/cm³, a tap density of 0.9 g/cm³, a cobalt content of 62.2 wt %, an average particle size of primary particles being 0.3 μm, an aspect ratio of granular particles being 1.10, and a content of hollow particles being 2%.

145.3 g of this cobalt hydroxide granule and 56.6 g of lithium carbonate having a lithium content of 18.7 wt %, were mixed and fired at 1,030° C. for 14 hours, followed by pulverization to obtain a powder of LiCoO₂. This LiCoO₂ had an average particle size D50 of 21.5 μm, D10 of 8.7 μm, D90 of 43.2 μm, a specific surface area of 0.40 m²/g and a press density of 3.44 g/cm³. The initial discharge capacity was 161 mAh/g, the capacity retention after the charge and discharge cycle test of 30 times was 95.0%, and the volume capacity density was 554 mAh/cm³. Further, the exothermic onset temperature was 161° C.

### Example 4

### Present Invention

A cobalt hydroxide granule was obtained in the same manner as in Example 1 except that the air flow rate was changed to 700 L/min. The obtained granule had an average particle size D50 of 16.0 μm, D10 of 5.4 μm and D90 of 26.1 μm. The average pore size was 0.14 μm, and the porosity was 84%. The granule had a specific surface area of 33.4 m²/g, a repose angle of 52°, a bulk density of 0.6 g/cm³, a tap density of 0.8 g/cm³, a cobalt content of 61.8 wt %, an average particle size of primary particles being 0.3 μm, an aspect ratio of granular particles being 1.15, and a content of hollow particles being 0%.

145.3 g of this cobalt hydroxide granule and 56.6 g of lithium carbonate having a lithium content of 18.7 wt %, were mixed and fired at 1,030° C. for 14 hours, followed by pulverization to obtain a powder of LiCoO₂. This LiCoO₂ had an average particle size D50 of 14.0 μm, D10 of 7.0 μm, D90 of 25.4 μm, a specific surface area of 0.39 m²/g and a press density of 3.29 g/cm³. The initial discharge capacity was 161 mAh/g, the capacity retention after the charge and discharge cycle test of 30 times was 95.7%, and the volume capacity density was 530 mAh/cm³. Further, the exothermic onset temperature was 162° C.

### Example 5

### Present Invention

A cobalt hydroxide granule was obtained in the same manner as in Example 1 except that the air flow rate was changed to 1,000 L/min. The obtained granule had an average particle size D50 of 10.0 μm, D10 of 3.7 μm and D90 of 21.0 μm. The average pore size was 0.12 μm, and the porosity was 73%. The granule had a specific surface area of 37.2 m²/g, a repose angle of 45°, a bulk density of 0.5 g/cm³, a tap density of 0.8 g/cm³, a cobalt content of 61.8 wt %, an average particle size of primary particles being 0.3 μm, an aspect ratio of granular particles being 1.09, and a content of hollow particles being 0%.

146.3 g of this cobalt hydroxide granule and 56.6 g of lithium carbonate having a lithium content of 18.7 wt %, were mixed and fired at 1,030° C. for 14 hours, followed by pulverization to obtain a powder of LiCoO₂. This LiCoO₂ had an average particle size D50 of 9.5 μm, D10 of 5.8 μm, D90 of 17.3 μm, a specific surface area of 0.46 m²/g and a press density of 3.28 g/cm³. The initial discharge capacity was 161 mAh/g, the capacity retention after the charge and discharge cycle test of 30 times was 96.7%, and the volume capacity density was 528 mA/cm³. Further, the exothermic onset temperature was 162° C.

### Example 6

### Present Invention

In 30 kg of water, 20 kg of cobalt hydroxide particles were dispersed. The cobalt hydroxide particles dispersed in the slurry had a dispersed average particle size of 0.6 μm and D90 of 1.5 μm. The slurry had a viscosity of 5 mPa·s, a solid content concentration of 40 wt % and a sedimentation degree of 0.85. This slurry was spray-dried at an air flow rate of 400 L/min to obtain a cobalt hydroxide granule. The obtained granule had an average particle size D50 of 19.0 μm, D10 of 6.7 μm and D90 of 32.4 μm. The average pore size was 0.24 μm, and the porosity was 69%. The granule had a specific surface area of 8.5 m²/g, a repose angle of 58°, a bulk density of 0.7 g/cm³, a tap density of 0.9 g/cm³, a cobalt content of 62.5 wt %, an average particle size of primary particles being 0.5 μm, an aspect ratio of granular particles being 1.17, and a content of hollow particles being 0%.

144.6 g of this cobalt hydroxide granule and 56.6 g of lithium carbonate having a lithium content of 18.7 wt %, were mixed and fired at 1,030° C. for 14 hours, followed by pulverization to obtain a powder of LiCoO₂. This LiCoO₂ had an average particle size D50 of 15.8 μm, D10 of 6.7 μm, D90 of 27.4 μm, a specific surface area of 0.41 m²/g and a press density of 3.35 g/cm³. The initial discharge capacity was 161 mAh/g, the capacity retention after the charge and discharge cycle test of 30 times was 96.1%, and the volume capacity density was 539 mAh/cm³. Further, the exothermic onset temperature was 162° C.

### Example 7

### Present Invention

In 30 kg of water, 20 kg of cobalt oxyhydroxide particles were dispersed. The cobalt oxyhydroxide particles dispersed in the slurry had a dispersed average particle size of 0.6 μm and D90 of 1.65 μm. The slurry had a viscosity of 15 mPa·s, a solid content concentration of 35 wt % and a sedimentation degree of 0.96. This slurry was spray-dried at an air flow rate of 400 L/min to obtain a cobalt oxyhydroxide granule. The obtained granule had an average particle size D50 of 24.0 μm, D10 of 7.0 μm and D90 of 47.4 μm. The average pore size was 0.15 μm, and the porosity was 78%. The granule had a specific surface area of 88 m²/g, a repose angle of 50°, a bulk density of 0.8 g/cm³, a tap density of 1.0 g/cm³, a cobalt content of 62.4 wt %, an average particle size of primary particles being 0.6 μm, an aspect ratio of granular particles being 1.07, and a content of hollow particles being 0%.

144.8 g of this cobalt oxyhydroxide granule and 56.6 g of lithium carbonate having a lithium content of 18.7 wt %, were mixed and fired at 1,030° C. for 14 hours, followed by pulverization to obtain a powder of LiCoO₂. This LiCoO₂ had an average particle size D50 of 18.5 μm, D10 of 7.9 μm, D90 of 31.1 μm, a specific surface area of 0.43 m²/g and a press density of 3.32 g/cm³. The initial discharge capacity was 161 mAh/g, the capacity retention after the charge and discharge cycle test of 30 times was 94.9%, and the volume capacity density was 535 mAh/cm³. Further, the exothermic onset temperature was 162° C.

### Example 8

### Present Invention

A slurry was prepared in the same manner as in Example 1 except that 20 kg of cobalt hydroxide particles were dispersed in 30 kg of water. The cobalt hydroxide particles dispersed in the slurry had a dispersed average particle size of 0.5 μm and D90 of 1.2 μm. The slurry had a viscosity of 6 mPa·s, a solid content concentration of 40 wt % and a sedimentation degree of 0.89. Further, a cobalt hydroxide granule was obtained in the same manner as in Example 1 except that the air flow rate was changed to 400 L/min. The obtained granule had an average particle size D50 of 19.9 μm, D10 of 7.8 μm and D90 of 31.8 μm. The average pore size was 0.20 μm, and the porosity was 75%. The specific surface area was 13.6 m²/g, the repose angle was 54°, the aspect ratio was 1.13, the bulk density was 0.6 g/cm³, the tap density was 0.8 g/cm³, and the cobalt content was 62.5 wt %. The average particle size of primary particles was 0.4 μm, and the content of hollow particles was 0%.

144.6 g of this cobalt hydroxide granule and 56.6 g of lithium carbonate having a lithium content of 18.7 wt %, were mixed and fired at 1,030° C. for 14 hours, followed by pulverization to obtain a powder of LiCoO₂. This LiCoO₂ had an average particle size D50 of 16.0 μm, D10 of 6.7 μm, D90 of 27.9 μm, a specific surface area of 0.42 m²/g and a press density of 3.34 g/cm³. The initial discharge capacity was 161 mAh/g, the capacity retention after the charge and discharge cycle test of 30 times was 95.2%, and the volume capacity density was 538 mAh/cm³. Further, the exothermic onset temperature was 161° C.

### Example 9

### Present Invention

A slurry was prepared in the same manner as in Example 1 except that 20 kg of cobalt hydroxide particles were dispersed in 30 kg of water. The cobalt hydroxide particles dispersed in the slurry had a dispersed average particle size of 0.6 μm and D90 of 1.5 μm. The slurry had a viscosity of 3 mPa·s, a solid content concentration of 40 wt % and a sedimentation degree of 0.83. Further, a cobalt hydroxide granule was obtained in the same manner as in Example 1 except that the air flow rate was changed to 400 L/min. The obtained granule had an average particle size D50 of 19.0 μm, D10 of 6.7 μm and D90 of 32.4 μm. The average pore size was 0.24 μm, and the porosity was 73%. The specific surface area was 8.5 m²/g, the repose angle was 57°, the aspect ratio was 1.17, the bulk density was 0.7 g/cm³, the tap density was 0.9 g/cm³, and the cobalt content was 62.4 wt %. The average particle size of primary particles was 0.5 μm, and the content of hollow particles was 0%.

144.9 g of this cobalt hydroxide granule and 56.6 g of lithium carbonate having a lithium content of 18.7 wt %, were mixed and fired at 1,030° C. for 14 hours, followed by pulverization to obtain a powder of LiCoO₂. This LiCoO₂ had an average particle size D50 of 15.8 μm, D10 of 6.7 μm, D90 of 27.4 μm, a specific surface area of 0.41 m²/g and a press density of 3.35 g/cm³. The initial discharge capacity was 161 mAh/g, the capacity retention after the charge and discharge cycle test of 30 times was 96.7%, and the volume capacity density was 539 mAh/cm³. Further, the exothermic onset temperature was 162° C.

### Example 10

### Present Invention

12.3 g of magnesium hydroxide having a magnesium content of 41.6 wt %, 29 g of citric acid and 500 g of water were mixed and dissolved, and then, 126 g of an aqueous aluminum lactate solution having an aluminum content of 4.5 wt % and 66.2 g of an aqueous ammonium zirconium carbonate having a zirconium content of 14.6 wt %, were added, mixed and stirred. Further, water was added to prepare 2 kg of an additive element-containing solution. In 35.1 kg of water, 20 kg of cobalt hydroxide particles having a cobalt content of 62.2 wt % were dispersed, and then 2 kg of the additive element-containing solution was added, followed by stirring to prepare a slurry.

The cobalt hydroxide particles dispersed in the slurry had a dispersed average particle size of 0.3 μm and D90 of 0.5 μm. The slurry had a viscosity of 220 mPa·s, a solid content concentration of 35 wt % and a sedimentation degree of 0.98. Further, spray-drying was carried out at an air flow rate of 500 L/min to obtain a cobalt hydroxide granule containing aluminum, magnesium and zirconium. The obtained granule had an average particle size D50 of 22.0 μm, D10 of 6.8 μm and D90 of 50.7 μm. The average pore size was 0.11 μm, and the porosity was 75%. The granule had a specific surface area of 23.9 m²/g, a repose angle of 53°, a bulk density of 0.6 g/cm³, a tap density of 0.8 g/cm³, a cobalt content of 62.3 wt %, an average particle size of primary particles being 0.3 μm, an aspect ratio of granular particles being 1.12, and a content of hollow particles being 3%.

144.8 g of this cobalt hydroxide granule and 56.7 g of lithium carbonate having a lithium content of 18.7 wt %, were mixed and fired at 1,030° C. for 14 hours, followed by pulverization to obtain a powder of a lithium-containing composite oxide having a composition of LiCo_{0.9975}Al_{0.001}Mg_{0.001}Zr_{0.0005}O₂. This lithium-containing composite oxide had an average particle size D50 of 17.2 μm, D10 of 7.5 μm, D90 of 30.0 μm, a specific surface area of 0.44 m²/g and a press density of 3.28 g/cm³. The initial discharge capacity was 162 mAh/g, the capacity retention after the charge and discharge cycle test of 30 times was 99.1%, and the volume capacity density was 530 mAh/cm³. Further, the exothermic onset temperature was 162° C.

### Example 11

### Present Invention

1,283 g of an aqueous aluminum lactate solution having an aluminum content of 4.5 wt % and 67.4 g of an aqueous ammonium zirconium carbonate solution having a zirconium content of 14.6 wt %, were mixed and stirred, and further, water was added to prepare 2 kg of an additive element-containing solution. In 35.1 kg of water, 126 g of magnesium hydroxide having a magnesium content of 41.6 wt % and an average particle size of 0.3 μm and 20 kg of cobalt hydroxide particles having a cobalt content of 62.2 wt %, were dispersed and then, 2 kg of the additive element-containing solution was further added and stirred to prepare a slurry. Otherwise, in the same manner as in Example 1, a slurry was prepared. The cobalt hydroxide particles dispersed in the slurry had a dispersed average particle size of 0.3 μm and D90 of 0.5 μm. The slurry had a viscosity of 485 mPa·s, a solid content concentration of 35 wt % and a sedimentation degree of 0.99. Further, a cobalt hydroxide granule containing aluminum, magnesium and zirconium, was obtained in the same manner as in Example 1 except that the air flow rate was changed to 500 L/min. The obtained granule had an average particle size D50 of 26.0 μm, D10 of 7.6 μm and D90 of 50.8 μm. The average pore size was 0.13 μm, and the porosity was 70%. The specific surface area was 20.3 m²/g, the repose angle was 49°, the aspect ratio was 1.13, the bulk density was 0.6 g/cm³, the tap density was 0.8 g/cm³, and the cobalt content was 60.9%. The average particle size of primary particles was 0.3 μm, and the content of hollow particles was 5%.

142.6 g of this cobalt hydroxide granule and 58.3 g of lithium carbonate having a lithium content of 18.7 wt %, were mixed and fired at 1,030° C. for 14 hours, followed by pulverization to obtain a powder of a lithium-containing composite oxide having a composition of Li_{1.01}Co_{0.9970}Al_{0.01}Mg_{0.01}Zr_{0.0005}O₂. The powder of this lithium-containing composite oxide had an average particle size D50 of 19.0 μm, D10 of 8.8 μm, D90 of 32.0 μm, a specific surface area of 0.32 m²/g and a press density of 3.34 g/cm³. The initial discharge capacity was 154 mAh/g, the capacity retention after the charge and discharge cycle test of 30 times was 94.0%, and the volume capacity density was 514 mAh/cm³. Further, the exothermic onset temperature was 164° C.

### Example 12

### Present Invention

In 30 kg of water, 20 kg of co-precipitated nickel/cobalt/manganese composite oxyhydroxide particles represented by a composition of (Ni_{0.333}Co_{0.333}Mn_{0.333})OOH, was dispersed. The nickel/cobalt/manganese composite oxyhydroxide particles dispersed in the slurry had a dispersed average particle size of 0.5 μm and D90 of 1.0 μm. The slurry had a viscosity of 15 mPa·s, a solid content concentration of 40 wt % and a sedimentation degree of 0.93. This slurry was spray-dried at an inlet temperature of the drying chamber being 200° C. at an air flow rate of 500 L/min and at a liquid supply rate of 500 ml/min to obtain a spherical nickel/cobalt/manganese composite oxyhydroxide granule. The obtained granule had an average particle size D50 of 20.6 μm, D10 of 7.6 μm, D90 of 35.8 μm, an average pore size of 0.10 μm and a porosity 76%. The granule had a specific surface area of 53.1 m²/g, a repose angle of 46°, a bulk density of 0.6 g/cm³, a tap density of 0.8 g/cm³, a total content of nickel, cobalt and manganese being 62.1 wt %, an average particle size of primary particles being 0.4 μm, an aspect ratio of granular particles being 1.09, a content of hollow particles being 0%.

144.5 g of this composite oxyhydroxide granule and 63.7 g of lithium carbonate having a lithium content of 18.7 wt %, were mixed and fired at 1,000° C. for 14 hours, followed by pulverization to obtain a powder of a lithium-containing composite oxide represented by a composition of Li_{1.05}Ni_{0.317}Co_{0.317}Mn_{0.317}O₂. The powder of this lithium-containing composite oxide had an average particle size D50 of 17.6 μm, D10 of 7.3 μm, D90 of 29.3 μm, a specific surface area of 0.38 m²/g and a press density of 2.92 g/cm³. Further, the initial discharge capacity was 160 mAh/g, the capacity retention after the charge and discharge cycle test of 30 times was 95.3%, and the volume capacity density was 467 mAh/cm³. Further, the exothermic onset temperature was 227° C.

### Example 13

### Present Invention

In 30 kg of water, 20 kg of fine particles of co-precipitated nickel/cobalt/aluminum composite hydroxide represented by a composition of (Ni_{0.80}Co_{0.18}Al_{0.02})(OH)₂, were dispersed. The nickel/cobalt/aluminum composite hydroxide particles dispersed in the slurry had a dispersed average particle size of 0.6 μm and D90 of 1.1 μm. The slurry had a viscosity of 12 mPa·s, a solid content concentration of 40 wt % and a sedimentation degree of 0.90. This slurry was spray-dried at an inlet temperature of the drying chamber being 200° C., at an air flow rate of 500 L/min and at a liquid supply rate of 500 ml/min to obtain a spherical nickel/cobalt/aluminum composite hydroxide granule.

The obtained granule had an average particle size D50 of 19.6 μm, D10 of 7.1 μm, D90 of 32.4 μm, an average pore size of 0.16 μm and a porosity 78%. The granule had a specific surface area of 30.5 m²/g, a repose angle of 45°, a bulk density of 0.6 g/cm³, a tap density of 0.8 g/cm³, a total content of nickel, cobalt and aluminum being 62.3 wt %, an average particle size of primary particles being 0.5 μm, an aspect ratio of granular particles being 1.06, and a content of hollow particles being 0%.

144.6 g of this composite hydroxide granule and 67.3 g of lithium hydroxide monohydrate having a lithium content of 16.5 wt %, were mixed and fired at 500° C. for 5 hours, then mixed again and further fired at 800° C. for 10 hours, followed by pulverization to obtain a powder of a lithium-containing composite oxide represented by a composition of Li_{1.01}Ni_{0.79}Co_{0.18}Al_{0.02}O₂. The powder of this lithium-containing composite oxide had an average particle size D50 of 16.7 μm, D10 of 6.7 μm, D90 of 27.2 μm, a specific surface area of 0.43 m²/g and a press density of 3.25 g/cm³. Further, the initial discharge capacity was 200 mAh/g, the capacity retention after the charge and discharge cycle test of 30 times was 94.6%, and the volume capacity density was 650 mAh/cm³. Further, the exothermic onset temperature was 183° C.

### Example 14

### Present Invention

In 30 kg of water, 20 kg of particles of co-precipitated nickel/cobalt/manganese composite oxyhydroxide represented by a composition of (Ni_{0.50}Co_{0.30}Mn_{0.20})OOH, were dispersed. The nickel/cobalt/manganese composite oxyhydroxide dispersed in the slurry had a dispersed average particle size of 0.7 μm and D90 of 1.3 μm. The slurry had a viscosity of 10 mPa·s, a solid content concentration of 40 wt % and a sedimentation degree of 0.90. This slurry was spray-dried at an inlet temperature of the drying chamber being 200° C., at an air flow rate of 500 L/min and at a liquid supply rate of 500 ml/min to obtain a spherical nickel/cobalt/manganese composite oxyhydroxide granule. The obtained granule had an average particle size D50 of 18.1 μm, D10 of 6.4 μm, D90 of 30.1 μm, an average pore size of 0.26 μm and a porosity 73%. The granule had a specific surface area of 21.0 m²/g, a repose angle of 51°, a bulk density of 0.6 g/cm³, a tap density of 0.8 g/cm³, a total content of nickel, cobalt and manganese being 62.1 wt %, an average particle size of primary particles being 0.6 μm, an average aspect ratio of granular particles being 1.09, and a content of hollow particles being 0%.

144.8 g of this composite oxyhydroxide granule and 59.3 g of lithium carbonate having a lithium content of 18.7 wt %, were mixed and fired at 1,000° C. for 14 hours, followed by pulverization to obtain a powder of a lithium-containing composite oxide represented by a composition of Li_{1.02}Ni_{0.49}Co_{0.29}Mn_{0.20}O₂. The powder of this lithium-containing composite oxide had an average particle size D50 of 15.5 μm, D10 of 6.5 μm, D90 of 25.8 μm, a specific surface area of 0.41 m²/g and a press density of 2.96 g/cm³. Further, the initial discharge capacity was 175 mAh/g, the capacity retention after the charge and discharge cycle test of 30 times was 95.4%, and the volume capacity density was 518 mAh/cm³. Further, the exothermic onset temperature was 193° C.

### Example 15

### Comparative Example

In 30 kg of water, 20 kg of cobalt hydroxide particles were dispersed. The cobalt hydroxide dispersed in the slurry had a dispersed average particle size of 1.2 μm and D90 of 5.3 μm. The slurry had a viscosity of 2 mPa·s, a solid content concentration of 40 wt % and a sedimentation degree of 0.47. This slurry was subjected to the same operation as in Example 1 except that the air flow rate was changed to 500 L/min to obtain a cobalt hydroxide granule. The obtained granule had an average particle size D50 of 16.4 μm, D10 of 7.0 μm and D90 of 29.3 μm. The average pore size was 1.1 μm, and the porosity was 59%. The granule had a specific surface area of 12.2 m²/g, a repose angle of 59°, a bulk density of 0.9 g/cm³, a tap density of 1.3 g/cm³, a cobalt content of 62.6 wt %, an average particle size of primary particles being 1.3 μm, an aspect ratio of granular particles being 1.23, and a content of hollow particles being 0%.

144.5 g of this cobalt hydroxide granule and 56.6 g of lithium carbonate having a lithium content of 18.7 wt %, were mixed and fired at 1,030° C. for 14 hours, followed by pulverization to obtain a powder of LiCoO₂. This LiCoO₂ had an average particle size D50 of 15.8 μm, D10 of 6.8 μm, D90 of 27.3 μm, a specific surface area of 0.53 m²/g and a press density of 3.04 g/cm³. The initial discharge capacity was 162 mAh/g, the capacity retention after the charge and discharge cycle test of 30 times was 94.0%, and the volume capacity density was 492 mAh/cm³. Further, the exothermic onset temperature was 160° C.

### Example 16

### Comparative Example

By a crystallization method, cobalt hydroxide particles were precipitated, and the particles were permitted to grow to prepare a cobalt hydroxide powder having D50 of 20.1 μm, D10 of 15.9 μm and D90 of 26.1 μm. The average pore size was 5.9 μm, and the porosity was 56%. The granule had a specific surface area of 4.5 m²/g, a repose angle of 52°, a bulk density of 1.8 g/cm³, a tape density of 2.2 g/cm³, a cobalt content of 62.2%, an average particles size of primary particles being 1.5 μm, and an aspect ratio of granular particles being 1.13.

144.5 g of this cobalt hydroxide granule and 56.6 g of lithium carbonate having a lithium content of 18.7 wt %, were mixed and fired at 1,030° C. for 14 hours, followed by pulverization to obtain a powder of LiCoO₂. This LiCoO₂ had an average particle size D50 of 18.4 μm, D10 of 13.2 μm, D90 of 26.5 μm, a specific surface area of 0.20 m²/g and a press density of 2.92 g/cm³. The initial discharge capacity was 160 mAh/g, the capacity retention after the charge and discharge cycle test of 30 times was 95.1%, and the volume capacity density was 467 mAh/cm³. Further, the exothermic onset temperature was 160° C.

### Example 17

### Comparative Example

In 20 kg of water, 20 kg of cobalt hydroxide particles were dispersed. The cobalt hydroxide dispersed in the slurry had a dispersed average particle size of 0.3 μm and D90 of 0.55. The slurry had a viscosity of 25 mPa·s, a solid content concentration of 50 wt % and a sedimentation degree of 0.99. This slurry was spray-dried at an air flow rate of 500 L/min. The obtained granule had an average particle size D50 of 60.1 μm, D10 of 11.4 μm and D90 of 161 μm. The average pore size was 0.11 μm, and the porosity was 79%. The granule had a specific surface area of 12.8 m²/g, a repose angle of 64°, a bulk density of 0.6 g/cm³, a tap density of 0.8 g/cm³, a cobalt content of 62.4 wt %, an average particle size of primary particles being 0.3 μm, an aspect ratio of granular particles being 1.18, and a content of hollow particles being 13%.

144.8 g of this cobalt hydroxide granule and 56.6 g of lithium carbonate having a lithium content of 18.7 wt %, were mixed and fired at 1,030° C. for 14 hours, followed by pulverization to obtain a powder of LiCoO₂. This LiCoO₂ had an average particle size D50 of 22.3 μm, D10 of 7.5 μm, D90 of 58.2 μm, a specific surface area of 0.30 m²/g and a press density of 3.43 g/cm³. In the same manner as in Example 1, coating of an electrode was carried out, but since coarse particles are included, the coated electrode was covered with cuts, whereby it was not possible to prepare a battery.

### Example 18

### Comparative Example

In 80 kg of water, 20 kg of cobalt hydroxide particles were dispersed. The cobalt hydroxide dispersed in the slurry had a dispersed average particle size of 0.3 μm and D90 of 0.5 μm. The slurry had a viscosity of 3 mPa·s, a solid content concentration of 20 wt % and a sedimentation degree of 0.65. This slurry was granulated by spraying at an air flow rate of 1,000 L/min to obtain a cobalt hydroxide granule. The obtained granule had an average particle size D50 of 7.5 μm, D10 of 4.3 μm and D90 of 14.1 μm. The average pore size was 0.6 μm, and the porosity was 71%. The granule had a specific surface area of 61.7 m²/g, a repose angle of 58°, a bulk density of 0.5 g/cm³, a tap density of 0.8 g/cm³, a cobalt content of 62.3 wt %, an average particle size of primary particles being 0.4 μm, an aspect ratio of granular particles being 1.18, and a content of hollow particles being 11%.

145.0 g of this cobalt hydroxide granule and 56.6 g of lithium carbonate having a lithium content of 18.7 wt %, were mixed and fired at 1,050° C. for 14 hours, followed by pulverization to obtain a powder of LiCoO₂. This LiCoO₂ had an average particle size D50 of 8.3 μm, D10 of 4.7 μm, D90 of 19.5 μm, a specific surface area of 0.57 m²/g and a press density of 3.18 g/cm³. The initial discharge capacity was 161 mAh/g, the capacity retention after the charge and discharge cycle test of 30 times was 95.4%, and the volume capacity density was 512 mAh/g. Further, the exothermic onset temperature was 159° C.

### Example 19

### Comparative Example

126 g of an aqueous aluminum lactate solution having an aluminum content of 4.5 wt % and 66.2 g of an aqueous ammonium carbonate solution having a zirconium content of 14.6 wt % were mixed and stirred, and water was further added to prepare 2 kg of an additive element-containing solution. In 22.4 kg of water, 12.3 g of magnesium hydroxide having a magnesium content of 41.6 wt % and 20 kg of cobalt hydroxide particles having a cobalt content of 62.2 wt %, were dispersed, and further, 2 kg of the additive element-containing solution was added, followed by stirring to prepare a slurry. Otherwise, in the same manner as in Example 1, the slurry was prepared. The cobalt-hydroxide dispersed in the slurry had a dispersed average particle size of 0.3 μm and D90 of 0.5 μm. The slurry had a viscosity of 884 mPa·s, a solid content concentration of 45 wt % and a sedimentation degree of 0.99. Further, it was attempted to granulate particles by spray-drying in the same manner as in Example 1, the nozzle was clogged and the spray drying was not possible and granulation was not possible.

### Example 20

### Comparative Example

37.1 kg of water and 20 kg of cobalt hydroxide having an average particle size of 13 μm, were mixed, followed by pulverization by a beads mill using zirconia balls having a diameter of 0.5 mm for 2 hours. Particles after the pulverization had an average particle size of 0.3 μm. However, the slurry underwent a viscosity increase, and the fluidity was poor. Therefore, it was not possible to granulate the particles by spray drying.

With respect to the foregoing Examples 1 to 20, the characteristics of the slurries, the characteristics of the obtained transition metal compound granules, the characteristics of the lithium-containing composite oxide particles produced by using such transition metal compound granules and the characteristics of the positive electrodes for lithium secondary batteries produced by using such lithium-containing composite oxides, are summarized in Tables 1 to 3.

TABLE 1

| | | Slurry | | | | |
|---|---|---|---|---|---|---|
| | | Dispersed | | | | |
| | | average | | | Solid content | Sedimentation |
| | | particle | D90 | Viscosity | concentration | degree |
| Example | | size μm | μm | mPa · s | wt % | — |
| 1 | Present | 0.3 | 0.55 | 9 | 40 | 0.95 |
| | invention | | | | | |
| 2 | Present | 0.3 | 0.50 | 6 | 35 | 0.92 |
| | invention | | | | | |
| 3 | Present | 0.4 | 0.72 | 13 | 45 | 0.98 |
| | invention | | | | | |
| 4 | Present | 0.3 | 0.55 | 9 | 40 | 0.95 |
| | invention | | | | | |
| 5 | Present | 0.3 | 0.55 | 9 | 40 | 0.95 |
| | invention | | | | | |
| 6 | Present | 0.6 | 1.50 | 5 | 40 | 0.85 |
| | invention | | | | | |
| 7 | Present | 0.6 | 1.65 | 15 | 35 | 0.96 |
| | invention | | | | | |
| 8 | Present | 0.5 | 1.20 | 6 | 40 | 0.89 |
| | invention | | | | | |
| 9 | Present | 0.6 | 1.50 | 3 | 40 | 0.83 |
| | invention | | | | | |
| 10 | Present | 0.3 | 0.50 | 220 | 35 | 0.98 |
| | invention | | | | | |
| 11 | Present | 0.3 | 0.50 | 485 | 35 | 0.99 |
| | invention | | | | | |
| 12 | Present | 0.5 | 1.00 | 15 | 40 | 0.93 |
| | invention | | | | | |
| 13 | Present | 0.6 | 1.10 | 12 | 40 | 0.90 |
| | invention | | | | | |
| 14 | Present | 0.7 | 1.30 | 10 | 40 | 0.90 |
| | invention | | | | | |
| 15 | Comparative | 1.2 | 5.30 | 2 | 40 | 0.47 |
| | Example | | | | | |
| 16 | Comparative | — | — | — | — | — |
| | Example | | | | | |
| 17 | Comparative | 0.3 | 0.55 | 25 | 50 | 0.99 |
| | Example | | | | | |
| 18 | Comparative | 0.3 | 0.50 | 3 | 20 | 0.65 |
| | Example | | | | | |
| 19 | Comparative | 0.3 | 0.50 | 884 | 45 | 0.99 |
| | Example | | | | | |
| 20 | Comparative | 13 [symbol] 0.3 | 1.20 | — | 35 | 0.43 |
| | Example | | | | | |

TABLE 2

| | | Granule | | | | | | | | | | | |
|---|---|---|---|---|---|---|---|---|---|---|---|---|---|
| | | Primary | | | | Average | | Specific | | | | | |
| | | particle | | | | pore | | surface | | Aspect | Bulk | Tap | Content |
| | | size | D50 | D10 | D90 | size | Porosity | area | Repose | ratio | density | density | of hollow |
| Example | | μm | μm | μm | μm | μm | % | m²/g | angle ° | — | g/cm³ | g/cm³ | particles % |
| 1 | Present | 0.3 | 21.9 | 7.6 | 35.8 | 0.12 | 79 | 22.2 | 48 | 1.08 | 0.6 | 0.8 | 0 |
| | invention | | | | | | | | | | | | |
| 2 | Present | 0.3 | 27.4 | 9.0 | 50.9 | 0.14 | 81 | 22.5 | 51 | 1.06 | 0.6 | 0.8 | 0 |
| | invention | | | | | | | | | | | | |
| 3 | Present | 0.3 | 30.7 | 13.1 | 53.4 | 0.16 | 76 | 25.2 | 48 | 1.10 | 0.6 | 0.9 | 2 |
| | invention | | | | | | | | | | | | |
| 4 | Present | 0.3 | 16.0 | 5.4 | 26.1 | 0.14 | 84 | 33.4 | 52 | 1.15 | 0.6 | 0.8 | 0 |
| | invention | | | | | | | | | | | | |
| 5 | Present | 0.3 | 10.0 | 3.7 | 21.0 | 0.12 | 73 | 37.2 | 45 | 1.09 | 0.5 | 0.8 | 0 |
| | invention | | | | | | | | | | | | |
| 6 | Present | 0.5 | 19.0 | 6.7 | 32.4 | 0.24 | 69 | 8.5 | 58 | 1.17 | 0.7 | 0.9 | 0 |
| | invention | | | | | | | | | | | | |
| 7 | Present | 0.6 | 24.0 | 7.0 | 47.4 | 0.15 | 78 | 88.0 | 50 | 1.07 | 0.8 | 1.0 | 0 |
| | invention | | | | | | | | | | | | |
| 8 | Present | 0.4 | 19.9 | 7.8 | 31.8 | 0.20 | 75 | 13.6 | 54 | 1.13 | 0.6 | 0.8 | 0 |
| | invention | | | | | | | | | | | | |
| 9 | Present | 0.5 | 19.0 | 6.7 | 32.4 | 0.24 | 73 | 8.5 | 57 | 1.17 | 0.7 | 0.9 | 0 |
| | invention | | | | | | | | | | | | |
| 10 | Present | 0.3 | 22.0 | 6.8 | 50.7 | 0.11 | 75 | 23.9 | 53 | 1.12 | 0.6 | 0.8 | 3 |
| | invention | | | | | | | | | | | | |
| 11 | Present | 0.3 | 26.0 | 7.6 | 50.8 | 0.13 | 70 | 20.3 | 49 | 1.13 | 0.6 | 0.8 | 5 |
| | invention | | | | | | | | | | | | |
| 12 | Present | 0.4 | 20.6 | 7.6 | 35.8 | 0.10 | 76 | 53.1 | 46 | 1.09 | 0.6 | 0.8 | 0 |
| | invention | | | | | | | | | | | | |
| 13 | Present | 0.5 | 19.6 | 7.1 | 32.4 | 0.16 | 78 | 30.5 | 45 | 1.06 | 0.6 | 0.8 | 0 |
| | invention | | | | | | | | | | | | |
| 14 | Present | 0.6 | 18.1 | 6.4 | 30.1 | 0.26 | 73 | 21.0 | 51 | 1.09 | 0.6 | 0.8 | 0 |
| | invention | | | | | | | | | | | | |
| 15 | Comparative | 1.3 | 16.4 | 7.0 | 29.3 | 1.10 | 59 | 12.2 | 59 | 1.23 | 0.9 | 1.3 | 0 |
| | Example | | | | | | | | | | | | |
| 16 | Comparative | 1.5 | 20.1 | 15.9 | 26.1 | 5.90 | 56 | 4.5 | 52 | 1.13 | 1.8 | 2.2 | — |
| | Example | | | | | | | | | | | | |
| 17 | Comparative | 0.3 | 60.1 | 11.4 | 161.0 | 0.11 | 79 | 12.8 | 64 | 1.18 | 0.6 | 0.8 | 13 |
| | Example | | | | | | | | | | | | |
| 18 | Comparative | 0.4 | 7.5 | 4.3 | 14.1 | 0.60 | 71 | 61.7 | 58 | 1.18 | 0.5 | 0.8 | 11 |
| | Example | | | | | | | | | | | | |
| 19 | Comparative | — | — | — | — | — | — | — | — | — | — | — | — |
| | Example | | | | | | | | | | | | |
| 20 | Comparative | — | — | — | — | — | — | — | — | — | — | — | — |
| | Example | | | | | | | | | | | | |

TABLE 3

| | | Positive electrode material | | | | | | | | |
|---|---|---|---|---|---|---|---|---|---|---|
| | | | | | Specific | | | | Volume | Exothermic |
| | | | | | surface | Press | Discharge | | capacity | onset |
| | | D50 | D10 | D90 | area | density | capacity | Capacity | density | temperature |
| Example | | μm | μm | μm | m²/g | g/cm³ | mAh/g | retention % | mAh/cm³ | ° C. |
| 1 | Present | 17.5 | 8.0 | 27.3 | 0.38 | 3.34 | 161 | 95.7 | 538 | 162 |
| | invention | | | | | | | | | |
| 2 | Present | 19.2 | 8.3 | 33.8 | 0.40 | 3.38 | 161 | 97.8 | 544 | 162 |
| | invention | | | | | | | | | |
| 3 | Present | 21.5 | 8.7 | 43.2 | 0.40 | 3.44 | 161 | 95.0 | 554 | 161 |
| | invention | | | | | | | | | |
| 4 | Present | 14.0 | 7.0 | 25.4 | 0.39 | 3.29 | 161 | 95.7 | 530 | 162 |
| | invention | | | | | | | | | |
| 5 | Present | 9.5 | 5.8 | 17.3 | 0.46 | 3.28 | 161 | 96.7 | 528 | 162 |
| | invention | | | | | | | | | |
| 6 | Present | 15.8 | 6.7 | 27.4 | 0.41 | 3.35 | 161 | 96.1 | 539 | 162 |
| | invention | | | | | | | | | |
| 7 | Present | 18.5 | 7.9 | 31.1 | 0.43 | 3.32 | 161 | 94.9 | 535 | 162 |
| | invention | | | | | | | | | |
| 8 | Present | 16.0 | 6.7 | 27.9 | 0.42 | 3.34 | 161 | 95.2 | 538 | 161 |
| | invention | | | | | | | | | |
| 9 | Present | 15.8 | 6.7 | 27.4 | 0.41 | 3.35 | 161 | 96.7 | 539 | 162 |
| | invention | | | | | | | | | |
| 10 | Present | 17.2 | 7.5 | 30.0 | 0.44 | 3.28 | 162 | 99.1 | 530 | 162 |
| | invention | | | | | | | | | |
| 11 | Present | 19.0 | 8.8 | 32.0 | 0.32 | 3.34 | 154 | 94.0 | 514 | 164 |
| | invention | | | | | | | | | |
| 12 | Present | 17.6 | 7.3 | 29.3 | 0.38 | 2.92 | 160 | 95.3 | 467 | 227 |
| | invention | | | | | | | | | |
| 13 | Present | 16.7 | 6.7 | 27.2 | 0.43 | 3.25 | 200 | 94.6 | 650 | 183 |
| | invention | | | | | | | | | |
| 14 | Present | 15.5 | 6.5 | 25.8 | 0.41 | 2.96 | 175 | 95.4 | 518 | 193 |
| | invention | | | | | | | | | |
| 15 | Comparative | 15.8 | 6.8 | 27.3 | 0.53 | 3.04 | 162 | 94.0 | 492 | 160 |
| | Example | | | | | | | | | |
| 16 | Comparative | 18.4 | 13.2 | 26.5 | 0.20 | 2.92 | 160 | 95.1 | 467 | 160 |
| | Example | | | | | | | | | |
| 17 | Comparative | 22.3 | 7.5 | 58.2 | 0.30 | 3.43 | — | — | — | — |
| | Example | | | | | | | | | |
| 18 | Comparative | 8.3 | 4.7 | 19.5 | 0.57 | 3.18 | 161 | 95.4 | 512 | 159 |
| | Example | | | | | | | | | |
| 19 | Comparative | — | — | — | — | — | — | — | — | — |
| | Example | | | | | | | | | |
| 20 | Comparative | — | — | — | — | — | — | — | — | — |
| | Example | | | | | | | | | |

### INDUSTRIAL APPLICABILITY

From a lithium-containing composite oxide using as a raw material the transition metal compound granule of the present invention, it is possible to obtain a positive electrode for a lithium secondary battery, which has large volume capacity density and high safety and which is excellent in durability for charge and discharge cycles. The lithium secondary battery using such a positive electrode is widely useful as a power source which is small in size, light in weight and has a high energy density, for information related equipments, communication equipments, vehicles, etc.

The entire disclosures of Japanese Patent Application No. 2007-285509 filed on Nov. 1, 2007 and Japanese Patent Application No. 2007-285513 filed on Nov. 1, 2007 including specifications, claims, drawings and summaries are incorporated herein by reference in their entireties.

What is claimed is:

1. A transition metal compound granule serving as a raw material for a positive electrode material for a lithium ion secondary battery, which comprises particles containing at least one element selected from the group consisting of nickel, cobalt and manganese and having an average particle size of the primary particles being at most 1 μm and which is substantially spherical and has an average particle size D50 of from 10 to 40 μm and an average pore size of at most 1 μm.

2. The transition metal compound granule according to claim 1, which further contains at least one member selected from the group consisting of Ti, Zr, Hf, V, Nb, W, Ta, Mo, Sn, Zn, Mg, Ca, Ba and Al.

3. The transition metal compound granule according to claim 1, which has a porosity of from 60 to 90%.

4. The transition metal compound granule according to claim 1, which has an aspect ratio of at most 1.20.

5. The transition metal compound granule according to claim 1, which has a repose angle of at most 60°.

6. The transition metal compound granule according to claim 1, wherein the proportion of hollow particles is at most 10%.

7. The transition metal compound granule according to claim 1, which has D10 of from 3 to 12 μm.

8. The transition metal compound granule according to claim 1, which has D90 of at most 70 μm.

9. The transition metal compound granule according to claim 1, which has a specific surface area of from 4 to 100 m²/g.

10. The transition metal compound granule according to claim 1, wherein the transition metal compound is at least one member selected from the group consisting of a hydroxide, an oxyhydroxide, an oxide and a carbonate.

11. The transition metal compound granule according to claim 1, wherein the transition metal compound is cobalt hydroxide or cobalt oxyhydroxide.

12. A method for producing the transition metal compound granule as defined in claim 1, which comprises spray-drying a slurry having dispersed in water particles which are transition metal compound particles containing at least one element selected from the group consisting of nickel, cobalt and manganese and which have a dispersed average particle size of at most 1 μm.

13. The method for producing the transition metal compound granule according to claim 12, wherein the solid content concentration of the transition metal compound particles in the slurry is at least 35 wt %, and the viscosity of the slurry is from 2 to 500 mPa·s.

14. The method for producing the transition metal compound granule according to claim 12, wherein the slurry further contains a compound containing at least one element selected from the group consisting of Ti, Zr, Hf, V, Nb, Ta, Mo, W, Zn, Mg, Ca, Sn, Ba and Al.

15. The method for producing the transition metal compound granule according to claim 12, wherein the transition metal compound particles dispersed in the slurry have a dispersed average particle size of at most 0.5 μm.

16. The method for producing the transition metal compound granule according to claim 12, wherein the transition metal compound particles dispersed in the slurry have D90 of at most 5 μm.

17. The method for producing the transition metal compound granule according to claim 12, wherein the slurry has a sedimentation degree of at least 0.8.

18. The method for producing the transition metal compound granule according to claim 14, wherein the compound containing at least one element selected from the group consisting of Ti, Zr, Hf, V, Nb, Ta, Mo, W, Zn, Mg, Ca, Sn, Ba and Al, is contained as dissolved in the slurry, or such a compound is contained as dispersed in the form of particles.

19. The method for producing the transition metal compound granule according to claim 14, wherein the slurry contains the compound containing at least one element selected from the group consisting of Ti, Zr, Hf, V, Nb, Ta, Mo, W, Zn, Mg, Ca, Sn, Ba and Al, as dispersed in the form of powder particles in the slurry.

20. The method for producing the transition metal compound granule according to claim 19, wherein the dispersed average particle size of the powder particles dispersed in the slurry is at most twice the dispersed average particle size of the transition metal compound particles.

21. The method for producing the transition metal compound granule according to claim 12, wherein the slurry having the transition metal compound particles dispersed therein is a slurry obtained by precipitating and cleaning transition metal compound particles having a dispersed average particle size of at most 1 μm, and no pulverization step is included after the cleaning.

22. The method for producing the transition metal compound granule according to claim 12, wherein the transition metal compound is cobalt hydroxide, and the transition metal compound granule is a cobalt hydroxide granule.

23. A lithium-containing composite oxide obtained by mixing the transition metal compound granule as defined in claim 1, with a lithium compound, followed by firing.

24. A lithium cobalt composite oxide obtained by mixing the transition metal compound granule obtained by the method as defined in claim 22, with a lithium compound, followed by firing in an oxygen-containing atmosphere at a firing temperature of from 1,000 to 1,100° C.

25. A positive electrode for a lithium secondary battery, which comprises a cathode active material made of the lithium-containing composite oxide as defined in claim 23, an electroconductive material and a binder.

26. A lithium ion secondary battery comprising a positive electrode, a negative electrode, a non-aqueous electrolyte and an electrolytic solution, wherein the positive electrode is the positive electrode for a lithium secondary battery as defined in claim 25.
